(19) United States
(12) Patent Application Publication
(10) Pub. No.: US 2024/0148204 A1
(43) Pub. Date: May 9, 2024

(54) ROLLER ASSEMBLY AND VACUUM CLEANER INCLUDING THE SAME

(71) Applicant: Samsung Electronics Co., Ltd., Suwon-si (KR)

(72) Inventors: Taegwang KIM, Suwon-si (KR); Dongwoo HA, Suwon-si (KR); Sungwook KANG, Suwon-si (KR); Kihwan KWON, Suwon-si (KR); Yeonsu KIM, Suwon-si (KR); Jongwon MOON, Suwon-si (KR); Joongkyung PARK, Suwon-si (KR); Bonggyo SEO, Suwon-si (KR)

(73) Assignee: Samsung Electronics Co., Ltd., Suwon-si (KR)

(21) Appl. No.: 18/238,602

(22) Filed: Aug. 28, 2023

Related U.S. Application Data
(63) Continuation of application No. PCT/KR2023/095050, filed on Aug. 24, 2023.

(30) Foreign Application Priority Data
Nov. 7, 2022 (KR) 10-2022-0147377

(51) Int. Cl. A47L 9/00; B60B 19/12; B60B 35/00; B60B 35/04

(52) U.S. Cl. CPC A47L 9/009; B60B 19/12; B60B 35/004; B60B 35/04

(57) ABSTRACT

A roller assembly including a shaft, a first support body to which one end of the shaft is coupleable, a second support body to which another end of the shaft is coupleable, and a roller coupleable between the first support body and the second support body, having a cylindrical shape in which the shaft is insertable, and rotatably supported by the shaft. The first support body and the second support body respectively include a protrusion that protrudes toward side surfaces of the roller, the protrusion of the first support body and the second support body respectively protrude from the first support body and the second support body and are respectively insertable into spaces inside an outer circumference of the roller, and the roller includes accommodation grooves on both side surfaces of the roller and accommodate the protrusion of the first support body and the second support body with certain gaps, respectively.

### TECHNICAL FIELD

The disclosure relates to a roller assembly capable of performing a rolling movement, and a vacuum cleaner including the roller assembly.

### BACKGROUND ART

In general, a cleaner such as a vacuum cleaner or a steam cleaner is a device that uses a suction motor installed inside a main body to suck up air containing foreign substances such as dust, uses a filter inside the main body to remove the foreign substances from the air, and discharges the filtered air.

In general, a cleaner may include a cleaner body equipped with a suction motor, a suction port through which air containing foreign substances on a floor is sucked up, an air pipe through which the air sucked up through the suction port is moved to the cleaner body, a dust collector that stores the foreign substances separated from the air, a brush arranged at the suction port to collect the foreign substances on the floor, and a brush motor that supplies a rotational force to the brush.

In general, the cleaner uses the brush to be in close contact with a floor surface to smoothly suck up foreign substances, and moves the brush along a location where foreign substances are present. For moving the brush, a roller performing a rolling movement may be provided on the bottom of the brush.

In general, the roller of the cleaner is provided on the bottom surface of the brush to be in direct contact with the floor surface on which foreign substances are present and perform a rolling movement, and thus, the roller may easily get dirty with the foreign substances. When the roller becomes unable to roll due to inflow of hairs, threads, or the like, it becomes difficult to move the brush and change the direction of the brush, and in severe cases, the roller surface and the bottom surface may be scratched. Therefore, maintenance of the roller is required, such as preventing foreign substances from getting caught in the roller or separating the roller to remove foreign substances.

### DESCRIPTION OF EMBODIMENTS

### Solution to Problem

According to an embodiment of the disclosure, a roller assembly may include a shaft, a first support body to which one end of the shaft is coupleable, a second support body to which another end of the shaft is coupleable, and a roller coupleable between the first support body and the second support body.

The roller may be rotatably supported by the shaft while the shaft is inserted into the roller.

The roller may have a cylindrical shape in which the shaft is insertable.

The first support body may include a protrusion that protrudes toward a side surface of the roller while the roller is coupled between the first support body and the second support body.

The protrusion of the first support body protrudes from the first support body is insertable into a space inside an outer circumference of the roller.

The second support body may include a protrusion that protrudes toward a side surface of the roller while the roller is coupled between the first support body and the second support body.

The protrusion of the second support body protrudes from the second support body is insertable into a space inside an outer circumference of the roller.

The roller may include an accommodation groove on one side surface of the roller to accommodate the protrusion of the first support body with a certain gap between the accommodation groove and the protrusion of the first support body.

The roller may include an accommodation groove on another side surface of the roller to accommodate the protrusion of the second support body with a certain gap between the accommodation groove and the protrusion of the second support body.

The shaft of the roller may not be exposed to the outside of the roller assembly while the shaft is inserted into the roller.

According to an embodiment of the disclosure, a vacuum cleaner may include a vacuum cleaner body including a built-in motor configured to generate a suction force, a brush body connectable to the vacuum cleaner body and including a suction port to suck foreign substances from a surface to be cleaned, at least one roller assembly on a bottom surface of the brush body to cause the brush body to be rolling-moved on the surface to be cleaned, and at least one roller assembly accommodation unit arrangeable on the bottom surface of the brush body and having a structure corresponding to the at least one roller assembly such that the at least one roller assembly is able to be attached to or detached from the brush body.

The roller assembly may be provided on the bottom surface of the brush body.

The roller assembly may include a shaft, a first support body to which one end of the shaft is coupleable, a second support body to which another end of the shaft is coupleable, and a roller coupleable between the first support body and the second support body.

The roller may be rotatably supported by the shaft while the shaft is inserted into the roller.

The roller may have a cylindrical shape in which the shaft is insertable.

The first support body may include a protrusion that protrudes toward a side surface of the roller while the roller is coupled between the first support body and the second support body.

The protrusion of the first support body protrudes from the first support body is insertable into a space inside an outer circumference of the roller.

The second support body may include a protrusion that protrudes toward a side surface of the roller while the roller is coupled between the first support body and the second support body.

The protrusion of the second support body protrudes from the second support body is insertable into a space inside an outer circumference of the roller.

The roller may include an accommodation groove on one side surface of the roller to accommodate the protrusion of the first support body with a certain gap between the accommodation groove and the protrusion of the first support body.

The roller may include an accommodation groove on another side surface of the roller to accommodate the protrusion of the second support body with a certain gap between the accommodation groove and the protrusion of the second support body.

The shaft of the roller may not be exposed to the outside of the roller assembly while the shaft is inserted into the roller.

### BRIEF DESCRIPTION OF DRAWINGS

FIG. 1A is a perspective view of a roller assembly according to an embodiment of the disclosure.

FIG. 1B is a front view of a roller assembly according to an embodiment of the disclosure.

FIG. 2 is a cross-sectional view of an example of the roller assembly illustrated in FIG. 1A, taken along a line X-X.

FIG. 3 is an exploded perspective view of a roller assembly according to an embodiment of the disclosure.

FIG. 4A is an enlarged view illustrating that a roller is spaced apart from a floor surface, according to an embodiment of the disclosure.

FIG. 4B is an enlarged view illustrating that a roller performs a rolling movement on a floor surface, according to an embodiment of the disclosure.

FIG. 5A is a diagram illustrating that a roller assembly is accommodated in an object, according to an embodiment of the disclosure.

FIG. 5B is a cross-sectional view illustrating cross-sections of a roller assembly and an accommodation unit of an object, taken along a line Y-Y of FIG. 5A.

FIG. 5C is an enlarged view for describing an operation method of a snap-fit structure according to an embodiment of the disclosure.

FIG. 6 is a partial bottom view of a vacuum cleaner having a roller assembly, according to an embodiment of the disclosure.

### MODE OF DISCLOSURE

In the present specification, the principle of the disclosure is described and an embodiment of the disclosure are provided in such a manner that the scope of the disclosure becomes apparent and the disclosure may be carried out by those of skill in the art to which the disclosure pertains. The embodiment of the disclosure may be implemented in various forms.

As used in various examples of the disclosure, the expressions “include”, “may include”, and other conjugates refer to the existence of a corresponding disclosed function, operation, or constituent element, and do not limit one or more additional functions, operations, or constituent elements.

In addition, as used in various examples of the disclosure, the terms “include”, “have”, and other conjugates are intended merely to denote a certain feature, numeral, step, operation, element, component, or a combination thereof, and should not be construed to initially exclude the existence of or a possibility of addition of one or more other features, numerals, steps, operations, elements, components, or combinations thereof.

It should be understood that, when it is described that a first element is “connected” or “coupled” to a second element, the first element may be directly connected or coupled to the second element, and a third element may be connected or coupled between the first and second elements. On the other hand, it should be understood that, when it is described that a first element is “directly connected” or “directly coupled” to a second element, no further element is present between the first element and the second element.

As used herein, terms such as “first” or “second” may be used to describe various elements, but the elements should not be limited by the terms. These terms are only used to distinguish one element from another element.

An embodiment of the disclosure will be described with reference to the accompanying drawings in such a manner that the embodiment of the disclosure may be easily carried out by one of skill in the art. The disclosure may, however, be embodied in many different forms and should not be construed as being limited to the embodiment set forth herein. In order to clearly describe the disclosure, portions that are not relevant to the description of the disclosure are omitted, and similar reference numerals are assigned to similar elements throughout the present specification.

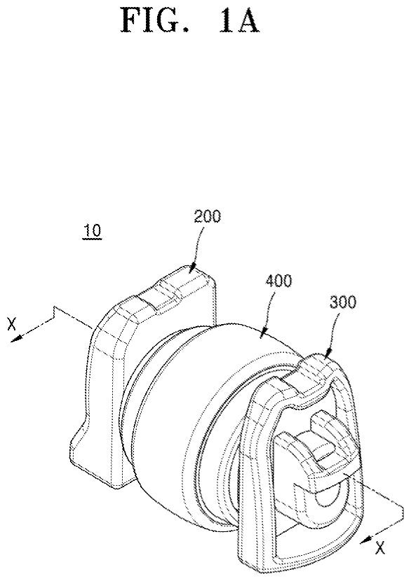

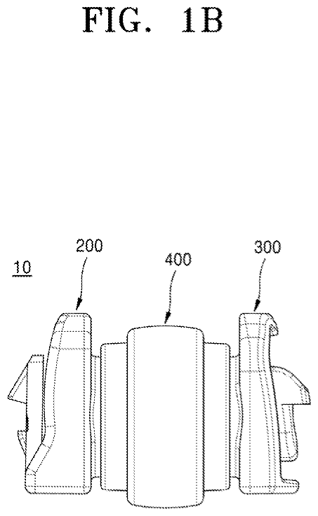

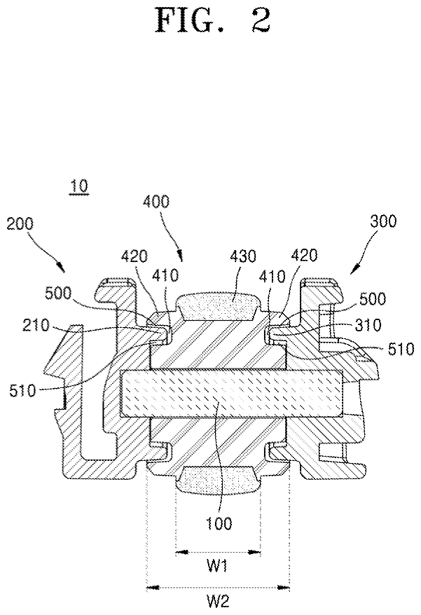

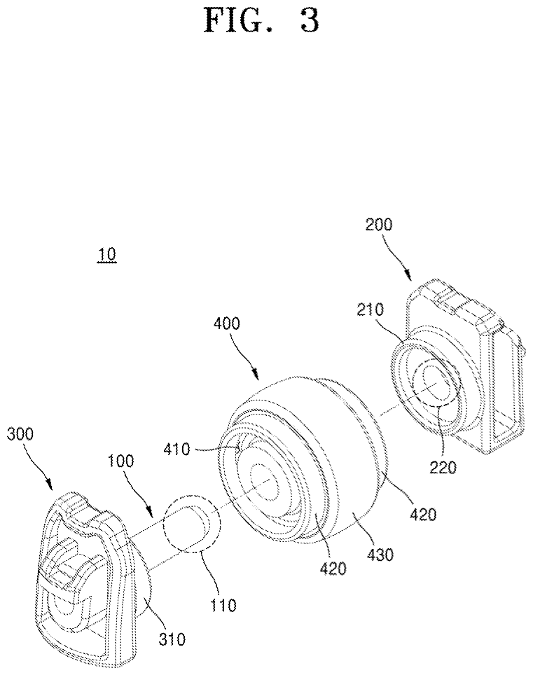

FIG. 1A is a perspective view of a roller assembly according to an embodiment of the disclosure. FIG. 1B is a front view of a roller assembly according to an embodiment of the disclosure. FIG. 2 is a cross-sectional view of an example of the roller assembly illustrated in FIG. 1A, taken along a line X-X. FIG. 3 is an exploded perspective view of a roller assembly according to an embodiment of the disclosure.

Referring to FIGS. 1A and 1B, a roller assembly 10 according to an embodiment of the disclosure is an independent element to perform a rolling movement function, or is provided on the bottom surface of an object in contact with a floor to perform a rolling movement function. For example, the roller assembly 10 may be provided on the bottom surface of a brush of a cleaner to perform a rolling movement to smoothly move and rotate the brush. However, the disclosure is not limited thereto and the roller assembly 10 may be used for an object requiring movement and rotation on a target surface such as a floor surface. For example, the roller assembly 10 may be provided on the bottom surface of a support of a desk or a chair in contact with a floor surface, to facilitate movement and rotation of the desk or chair.

Referring to FIGS. 2 and 3, the roller assembly 10 may include a shaft 100, a first support body 200 for fixing one end of the shaft 100, a second support body 300 for fixing the other end of the shaft 100, and a roller 400 that is between the first support body 200 and the second support body 300 and has a cylindrical shape into which the shaft 100 is inserted to support the roller 400 to rotate.

The shaft 100 passes through the roller 400 and supports the roller 400 to rotate. For example, the shaft 100 is fixed to the support bodies 200 and 300 and does not rotate, and the roller 400 supported by the shaft 100 rotates. However, the disclosure is not limited thereto, and the shaft 100 may be rotatably supported by the support bodies 200 and 300 such that the shaft 100 and the roller 400 may rotate together.

In an embodiment of the disclosure, there is a gap between the outer surface of the shaft 100 and the inner surface of the roller 400 facing the outer surface of the shaft 100, friction occurs between the outer surface of the shaft 100 and the inner surface of the roller 400 when the roller 400 rotates, and thus, the shaft 100 and the roller 400 may be provided with a structure and a material for minimizing the friction. In addition, the shaft 100 may include a material having stiffness for supporting the roller 400. For example, the shaft 100 may include a metal material or a strong plastic material having stiffness and lubricity. However, the disclosure is not limited thereto.

The first support body 200 may be at one end of the shaft 100 to fix the shaft 100. For example, the first support body 200 may fix the shaft 100 to prevent the shaft 100 from leaving its position due to a force applied to the shaft 100 supporting the roller 400, or from being rotated by friction between the outer surface of the shaft 100 and the inner surface of the roller 400 occurring when the roller 400 rotates.

In an embodiment of the disclosure, the first support body 200 may have a protrusion 210 that protrudes toward a side surface of the roller 400 facing the first support body 200 to be inserted into a space inside the outer circumference of the roller 400. The side surface of the roller 400 may be understood as the upper or lower surface of the cylindrical shape of the roller 400. The space inside the outer circumference of the roller 400 may be understood as a lower portion or an inner space of an outer circumferential surface 420 of the roller 400 provided in the cylindrical shape, with respect to the central axis 100 of the cylindrical shape. Accordingly, the first support body 200 engages with accommodation grooves 410 to be described below such that the direction of inflow of foreign substances is parallel to the shaft 100 (i.e., the horizontal direction in FIG. 2), and thus, it becomes difficult for foreign substances to flow into the shaft 100 inside the roller assembly 10.

In an embodiment of the disclosure, the protrusion 210 of the first support body 200 may protrude parallel to the shaft 100 to be spaced apart from the shaft 100 and to be between the shaft 100 and the outer circumference of the roller 400. For example, the cross-sectional shape of the protrusion 210 perpendicular to the shaft 100 may include a ring shape around the shaft 100, spaced apart from the shaft 100, and having a certain thickness. The certain thickness of the ring-shaped protrusion 210 may be understood as a thickness at which the protrusion 210 may be located inside the outer circumference of the roller 400 and spaced apart from the outer surface of the shaft 100, with respect to a cross-section perpendicular to the shaft 100. In a case in which the first support body 200 has a ring-shaped cross-section and protrudes parallel to the shaft 100, the first support body 200 engages with the accommodation grooves 410 to be described below to provide paths 500 and 510 parallel to the shaft 100 on a path for inflow of foreign substances such that the protrusion 210 acts as a kind of foreign substance inflow prevention bump. Accordingly, it is difficult for foreign substances to flow into the roller assembly 10, and even when foreign substances flow into the roller assembly 10, the foreign substances are discharged to the outside or stay at a position spaced apart from the shaft 100.

The second support body 300 may be at the other end of the shaft 100 to fix the shaft 100. For example, the second support body 300 may fix the shaft 100 to prevent the shaft 100 from leaving its position due to a force applied to the shaft 100 supporting the roller 400, or from being rotated by friction between the outer surface of the shaft 100 and the inner surface of the roller 400 occurring when the roller 400 rotates.

In an embodiment of the disclosure, the second support body 300 may have a protrusion 310 that protrudes toward a side surface of the roller 400 facing the second support body 300 to be inserted into a space inside the outer circumference of the roller 400. The side surface of the roller 400 may be understood as the upper or lower surface of the cylindrical shape of the roller 400. The space inside the outer circumference of the roller 400 may be understood as a lower portion or an inner space of an outer circumferential surface 420 of the roller 400 provided in the cylindrical shape, with respect to the central axis 100 of the cylindrical shape. Accordingly, the second support body 300 engages with the accommodation grooves 410 to be described below such that the direction of inflow of foreign substances is parallel to the shaft 100 (i.e., the horizontal direction in FIG. 2), and thus, it becomes difficult for foreign substances to flow into the shaft 100 inside the roller assembly 10.

In an embodiment of the disclosure, the protrusion 310 of the second support body 300 may protrude parallel to the shaft 100 to be spaced apart from the shaft 100 and to be between the shaft 100 and the outer circumference of the roller 400. For example, in a cross-section view perpendicular to the shaft 100, the protrusion 310 may be spaced apart from the shaft 100 to have a ring shape around the shaft 100 with a certain thickness. The certain thickness of the ring-shaped protrusion 310 may be understood as a thickness at which the protrusion 310 may be located inside the outer circumference of the roller 400 and spaced apart from the outer surface of the shaft 100, with respect to a cross-section perpendicular to the shaft 100. In a case in which the second support body 300 has a ring-shaped cross-section and protrudes parallel to the shaft 100, the second support body 300 engages with the accommodation grooves 410 to be described below to provide the paths 500 and 510 parallel to the shaft 100 on a path for inflow of foreign substances such that the protrusion 310 acts as a kind of foreign substance inflow prevention bump. Accordingly, it is difficult for foreign substances to flow into the roller assembly 10, and even when foreign substances flow into the roller assembly 10, the foreign substances are discharged to the outside or stay at a position spaced apart from the shaft 100.

In an embodiment of the disclosure, the roller 400 may have the accommodation grooves 410 accommodating the protrusions 210 and 310 with certain gaps with the protrusions 210 and 310, on the side surfaces thereof facing the support bodies 200 and 300. The certain gaps provided between the protrusions 210 and 310 and the accommodation grooves 410 may be understood as gaps required for the roller 400 to rotate without being fixed by the protrusions 210 and 310 when the protrusions 210 and 310 are inserted into the spaces inside the outer circumference of the side surface of the roller 400.

In an embodiment of the disclosure, the accommodation grooves 410 may be provided to face the outer circumferential surfaces and the inner circumferential surfaces of the protrusions 210 and 310 in parallel. In an embodiment of the disclosure, the accommodation grooves 410 may be provided to face the outer circumferential surfaces of the protrusions 210 and 310 in parallel. In an embodiment of the disclosure, the accommodation grooves 410 may be provided to facie the inner circumferential surfaces of the protrusions 210 and 310 in parallel. It may be understood that, in the outer surfaces formed by the ring-shaped protrudes 210 and 310, the inner circumferential surfaces of the protrusions 210 and 310 are the outer surfaces parallel to the shaft 100 and close to the shaft 100, the outer circumferential surfaces of the protrusions 210 and 310 are the outer surfaces parallel to the shaft 100 and far from the shaft 100. Facing an element in parallel may mean facing the element while maintaining a certain distance (or gap) to the element. For example, referring to FIGS. 2 and 3, when the cross-sections of the protrusions 210 and 310 are provided in a ring shape, the accommodation grooves 410 may be recessed in ring shapes from both sides of the roller 400 to correspond to the shapes of the protrusions 210 and 310. Accordingly, gaps 500 formed between the outer circumferential surfaces of the protrusions 210 and 310 and the accommodation grooves 410 corresponding thereto may be provided at a constant separation distance along a direction parallel to the shaft 100, and gaps 510 formed between the inner circumferential surfaces of the protrusions 210 and 310 and the accommodation grooves 410 corresponding thereto may be provided at a constant separation distance along a direction parallel to the shaft 100. Here, the gaps 500 formed between the outer circumferential surfaces of the protrusions 210 and 310 and the corresponding accommodation grooves 410 and the gaps 510 formed between the inner circumferential surfaces of the protrusions 210 and 310 and the corresponding accommodation grooves 410 may differ from each other in separation distance.

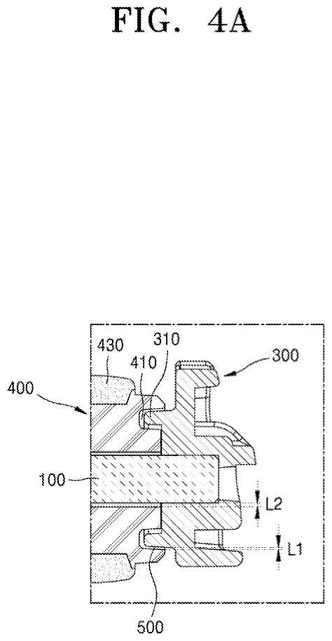

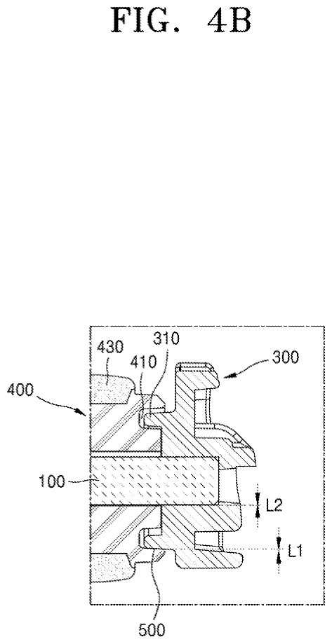

FIG. 4A is an enlarged view illustrating that a roller is spaced apart from a floor surface, according to an embodiment of the disclosure. FIG. 4B is an enlarged view illustrating that a roller performs a rolling movement on a floor surface, according to an embodiment of the disclosure.

Referring to FIG. 4A, in an embodiment of the disclosure, the accommodation grooves 410 may be spaced apart from the outer circumferential surface of the protrusions 210 and 310 by 0.2 mm or less in a direction perpendicular to the shaft 100. In an embodiment of the disclosure, the accommodation grooves 410 may be spaced apart from the outer circumferential surface of the protrusions 210 and 310 by 0.05 mm to 0.2 mm in a direction perpendicular to the outer circumferential surface of the protrusions 210 and 310. In an embodiment of the disclosure, the accommodation grooves 410 may be spaced apart from the outer circumferential surface of the protrusions 210 and 310 by 0.05 mm to 0.1 mm in a direction perpendicular to the outer circumferential surface of the protrusions 210 and 310. For example, in a case in which the accommodation grooves 410 and the outer circumferential surfaces of the protrusions 210 and 310 face each other in parallel, the gaps 500 formed between the outer circumferential surfaces of the protrusions 210 and 310 and the corresponding accommodation grooves 410 may correspond to an inlet through which foreign substances may flow into the roller assembly 10, and factors to be considered in designing the separation distances of the gaps 500 may include the sizes of foreign substances and a change in gap between components during a rolling movement of the roller assembly 10. Foreign substances that may flow into the roller assembly 10 and get entangled in the shaft 100 to disturb the rolling of the roller 400 may include hairs or animal hairs, and typically have a diameter of 0.1 mm. In addition, in order for the roller 400 to be supported by the shaft 100 and rotate, the roller 400 needs to be spaced apart from the shaft 100 (L2 in FIG. 4A), and when the roller 400 performs a rolling movement, the roller 400 is lifted by the floor surface and the shaft 100 is brought into contact with the roller 400 at one side (see L2 of FIG. 4A and L2 of FIG. 4B). In addition, in order for the roller 400 to roll, the accommodation grooves 410 need to be spaced apart from the outer circumferential surfaces of the protrusions 210 and 310. In consideration of this, the separation distances between the accommodation grooves 410 and the outer circumferential surfaces of the protrusions 210 and 310 may be maintained at 0.1 mm or less, and may be 0.05 mm to 0.2 mm when the roller assembly 10 is spaced apart from the floor surface.

Referring to FIGS. 2 and 3, in an embodiment of the disclosure, the roller 400 may include a friction member 430 surrounding the outer circumferential surface 420 of the roller 400, with a preset thickness and width. The friction member 430 is brought into contact with the floor surface prior to the outer circumferential surface 420 of the roller 400, and allows the roller 400 to smoothly roll through friction between the friction member 430 and the floor surface. Because the friction member 430 protrudes from the outer circumferential surface 420 to the preset thickness, the outer circumferential surface 420 of the roller 400 may be spaced apart from the floor surface and is less likely to be brought into contact with foreign substances.

In an embodiment of the disclosure, a width W1 of the friction member 430 may be less than a width W2 of the outer circumferential surface 420 of the roller 400. Foreign substances on the floor surface are attached to the friction member 430 that is first brought into contact therewith, and then collected and moves along the outer circumferential surface 420 of the roller 400. Accordingly, the frequency of attachment of foreign substances to the outer circumferential surface 420 of the roller 400 at both sides of the friction member 430 is reduced. In addition, because the outer circumferential surface 420 of the roller 400 is spaced apart from the floor surface by the friction member 430 protruding with the preset thickness, it is difficult for the foreign substances to be attached to the outer circumferential surface 420, and even when attached, they are highly likely to be separated from the outer circumferential surface 420 as the roller 400 rolls. As a result, the foreign substances are less likely to flow into the gaps 500 formed by the accommodation grooves 410 and the outer circumferential surfaces of the protrusions 210 and 310. On the contrary, in a case in which the width W1 of the friction member 430 is equal or similar to the width W2 of the outer circumferential surface 420, the outer circumferential surface 420 of the roller 400 spaced apart from the floor surface is reduced, and accordingly, foreign substances that are not attached to the friction member 430 and escape through both sides are highly likely to flow into the roller assembly 10 rather than flowing through the gap between the outer circumferential surface 420 of the roller 400 and the floor surface. In consideration of this, the width W1 of the friction member 430 may be less than the width W2 of the outer circumferential surface 420 of the roller 400.

In an embodiment of the disclosure, the friction member 430 may include a material different from that of the roller 400. As described above, the friction member 430 may include a material that generates a certain frictional force with a floor to allow the roller 400 to smoothly roll, and may include an elastic material to allow the outer circumferential surface 420 of the roller 400 to be spaced apart from the floor surface. For example, the friction member 430 may include rubber or the like. However, the disclosure is not limited thereto. On the contrary, the roller 400 may be formed of a material that is resistant to friction and abrasion and able to reduce impact with the floor surface in order to maintain a shape for a rolling movement. For example, the roller 400 may include polyoxymethylene (POM), nylon, or the like. However, the disclosure is not limited thereto. In an embodiment of the disclosure, the outer circumferential surface 420 of the roller 400 may be surface-treated to increase lubricity such that foreign substances are not attached thereto, and even when temporarily attached, may be removed therefrom.

Regarding a separation structure of the roller assembly 10 in an embodiment of the disclosure, referring to FIG. 3, the roller assembly 10 may be fixed as one end 110 of the shaft 100 is detachably inserted into insertion groove 220 provided in the support body 200 or 300 that the one end 110 faces. Accordingly, even when foreign substances flow into the roller assembly 10 and get caught or tangled in the shaft 100, the roller assembly 10 may be easily disassembled into the support bodies 200 and 300, the shaft 100, and the roller 400 to remove the foreign substances and then reassembled. Here, the other end of the shaft 100 may be integrally formed with the other support body 200 or 300. Accordingly, undesired separation between the shaft 100 and the support bodies 200 and 300 may be minimized, and at the same time, disassembly of the roller assembly 10 for removing foreign substances may be easily performed. However, the disclosure is not limited thereto, and both ends of the shaft 100 may be detachably inserted into and coupled with the support bodies 200 and 300, and may be provided to be separable in addition to the insertion and fixation. For example, a male screw may be provided in the one end 110 of the shaft 100 and a female screw may be provided in the insertion groove 220 of the support body 200 or 300 facing the one end 110 such that the screws may engage with each other.

In an embodiment of the disclosure, the cross-sectional shape of the one end 110 of the shaft 100 may be a polygonal or elliptic cylinder shape. This is to prevent mutual rotation of the support bodies 200 and 300 on both sides of the roller 400 when the shaft 100 is detachably inserted into and coupled with the support bodies 200 and 300. However, the cross-sectional shape of the one end 110 of the shaft 100 is not limited to a polygonal or elliptical shape, and may include any shape that allows the one end 110 to be inserted into the support body 200 or 300 to provide directionality and thus prevent rotation of the support bodies 200 and 300.

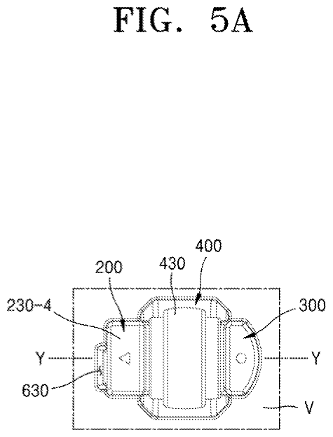

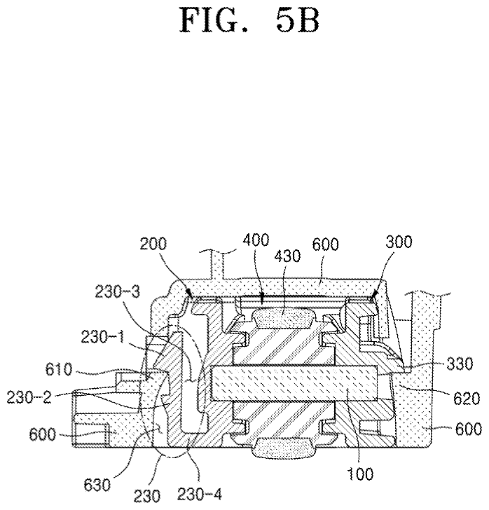

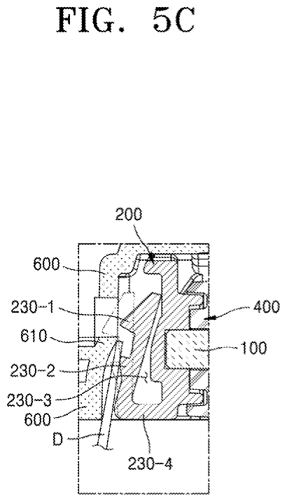

FIG. 5A is a diagram illustrating that the roller assembly 10 is accommodated in an object, according to an embodiment of the disclosure. FIG. 5B is a cross-sectional view illustrating cross-sections of the roller assembly 10 and an accommodation unit of the object, taken along a line Y-Y of FIG. 5A. FIG. 5C is an enlarged view for describing an operation method of a snap-fit structure according to an embodiment of the disclosure.

Referring to FIG. 5A, in an embodiment of the disclosure, the roller assembly 10 may be provided to be detachable from an object V. Accordingly, even when foreign substances are caught in the shaft 100 of the roller assembly 10, it is possible to detach the roller assembly 10 from the object V, disassemble the roller assembly 10 into the support bodies 200 and 300, the shaft 100, and the roller 400 to remove the foreign substances, and then combine the roller assembly 10 with the object V. The object V refers to a product that needs to move and rotate on a target surface such as a floor surface and thus is expected to use the roller assembly 10, and may be, for example, a bottom surface of a cleaner brush, a support of a desk or a chair, or the like.

Referring to FIGS. 5A to 5C, in an embodiment of the disclosure, a coupling unit 230 having a snap-fit structure may be provided on an outer side of the first support body 200, and a second engagement protrusion 330 may be provided on an outer side of the second support body 300. Here, in the support bodies 200 and 300 on both sides of the roller 400 with the roller 400 therebetween, the outer side may refer to a side opposite to an inner side of the support bodies 200 and 300 on which the roller 400 is located. The second engagement protrusion 330 engages with an accommodation unit 600 of the object V to fix the insertion position, and the coupling unit 230 having the snap-fit structure is fitted and coupled to the accommodation unit 600 of the object V, and the coupling is released by using a screwdriver D to press the snap-fit structure having elasticity. Accordingly, attachment and detachment are easily performed by using the components of the roller assembly 10 without bolts, and thus, convenient maintenance may be provided. Here, of course, an engagement protrusion may be provided on an outer portion of the first support body 200 and the coupling unit 230 having the snap-fit structure may be provided on an outer portion of the second support body 300. In addition, without being limited thereto, a snap-fit structure may be provided on an outer portion of the first support body 200 and another snap-fit structure may be provided on an outer portion of the second support body 300.

In an embodiment of the disclosure, the coupling unit 230 may include, in the snap-fit structure, a beam including a first engagement protrusion 230-1 and a pressing protrusion 230-2, and a bridge 230-4 connecting the first support body 200 to the beam with a gap 230-3 therebetween. The first engagement protrusion 230-1 is provided at an end of the beam to fix the roller assembly 10 to the accommodation unit 600 of the object V through engagement (or hooking). The pressing protrusion 230-2 is between the beam and the bridge 230-4, and when the pressing protrusion 230-2 is pressed with a tool such as the screwdriver D, releases the fixation of the first engagement protrusion 230-1. The bridge 230-4 connects the beam to the first support body 200 and forms the gap 230-3 between the beam and the first support body 200 to provide a space in which the engagement of the first engagement protrusion 230-1 is released when the pressing protrusion 230-2 is pressed with the screwdriver D or the like. Accordingly, the roller assembly 10 may be easily detached from the object V by lightly pressing the pressing protrusion 230-2 with the screwdriver D or the like.

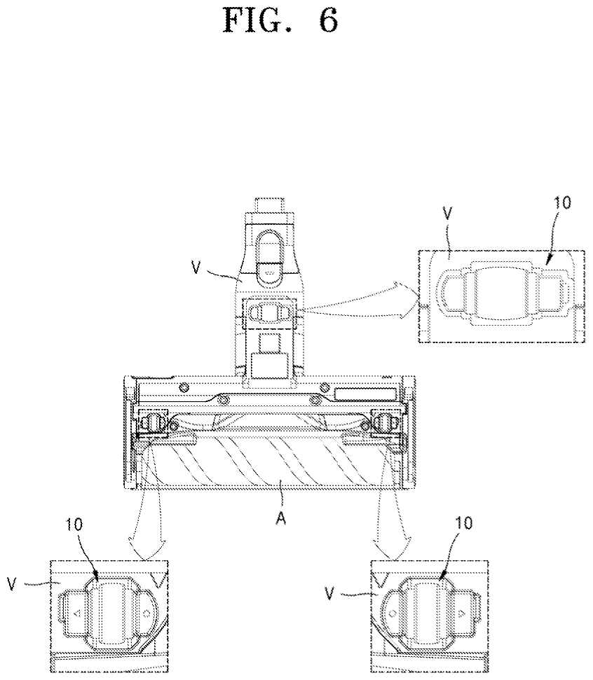

FIG. 6 is a partial bottom view of a vacuum cleaner having the roller assembly 10, according to an embodiment of the disclosure.

Hereinafter, descriptions will be provided with reference to FIGS. 5A to 6, the description of the above-described roller assembly 10 will be provided with the same reference numerals, and redundant descriptions will be omitted or briefly provided. Components with the same reference numerals throughout the present specification indicate that they have the same structures, functions, and effects, and may be understood as having the same possible modifications.

A vacuum cleaner according to an embodiment of the disclosure may include a cleaner body (not shown) having a built-in motor for generating a suction force, a brush body V connected to the cleaner body and provided with a suction port through which foreign substances are sucked from a surface to be cleaned, at least one roller assembly 10 provided on the bottom surface of the brush body V to cause the brush body V to be rolling-moved on the surface to be cleaned, and at least one roller assembly accommodation unit 600 provided on the bottom surface of the brush body V to have a structure corresponding to the roller assembly 10 such that the roller assembly 10 may be attached to or detached from the brush body V.

The cleaner body and the brush body V may be understood as having common structures and functions in the field of vacuum cleaners.

Referring to FIG. 6, in an embodiment of the disclosure, the positions of the roller assembly 10 and the roller assembly accommodation unit 600 may be determined considering the structure of the brush body V applied thereto, and a plurality of roller assemblies 10 and a plurality of roller assembly accommodation units 600 may be provided. For example, in a case in which a drum A is provided in front of the brush body V, the roller assembly 10 and the roller assembly accommodation unit 600 may be provided on each of both sides of the brush body V in the rear of the drum A, and in a case in which a portion connecting the brush body V to the cleaner body is attached to the bottom surface, the roller assembly 10 and the roller assembly accommodation unit 600 may also be provided at the connecting portion.

Referring to FIGS. 2, 3, and 6, in an embodiment of the disclosure, the roller assembly 10 may include the shaft 100, the first support body 200 for fixing one end of the shaft 100, the second support body 300 for fixing the other end of the shaft 100, and the roller 400 that is between the first support body 200 and the second support body 300 and has a cylindrical shape into which the shaft 100 is inserted to support the roller 400 to rotate.

In an embodiment of the disclosure, the first support body 200 and the second support body 300 may have the protrusions 210 and 310 that protrude toward side surfaces of the roller 400 respectively facing the first support body 200 and the second support body 300 to be inserted into spaces inside the outer circumference of the roller 400.

In an embodiment of the disclosure, the roller 400 may have the accommodation grooves 410 that are arranged on both sides of the roller 400 and accommodate the protrusions 210 and 310 with certain gaps, respectively.

In an embodiment of the disclosure, the protrusions 210 and 310 may protrude parallel to the shaft 100, and in a cross-sectional view perpendicular to the shaft 100, may be spaced apart from the shaft 100 to have a ring shape around the shaft 100 with a certain thickness.

In an embodiment of the disclosure, the accommodation grooves 410 may be provided to face the outer circumferential surfaces and the inner circumferential surfaces of the protrusions 210 and 310 in parallel.

In an embodiment of the disclosure, the roller 400 may include the friction member 430 surrounding the outer circumferential surface 420 of the roller 400, with a certain thickness and width.

Referring to FIGS. 4A, 4B, and 6, in an embodiment of the disclosure, the accommodation grooves 410 may be spaced apart from the outer circumferential surface of the protrusions 210 and 310 by 0.2 mm or less in a direction perpendicular to the shaft 100. In an embodiment of the disclosure, the accommodation grooves 410 may be spaced apart from the outer circumferential surface of the protrusions 210 and 310 by 0.05 mm to 0.2 mm in a direction perpendicular to the outer circumferential surface of the protrusions 210 and 310. In an embodiment of the disclosure, the accommodation grooves 410 may be spaced apart from the outer circumferential surface of the protrusions 210 and 310 by 0.05 mm to 0.1 mm in a direction perpendicular to the outer circumferential surface of the protrusions 210 and 310.

Referring to FIGS. 2 and 6, in an embodiment of the disclosure, the width W1 of the friction member 430 may be less than the width W2 of the outer circumferential surface 420 of the roller 400.

In an embodiment of the disclosure, the friction member 430 may be formed of a material different from that of the roller 400.

Referring to FIGS. 3 and 6, in an embodiment of the disclosure, the cross-sectional shape of the one end 110 of the shaft 100 may be a polygonal or elliptic cylinder shape.

In an embodiment of the disclosure, the support body 200 or 300 facing the one end 110 of the shaft 100 may have the insertion groove 220 corresponding to the shape of the one end 110 of the shaft 100, such that the one end 110 of the shaft 100 is detachably inserted into and coupled with the facing support body 200 or 300.

Referring to FIGS. 5A to 6, in an embodiment of the disclosure, the coupling unit 230 having a snap-fit structure may be provided on an outer side of the first support body 200, and the second engagement protrusion 330 may be provided on an outer side of the second support body 300.

In an embodiment of the disclosure, the coupling unit 230 may include a beam including the first engagement protrusion 230-1 and the pressing protrusion 230-2, and the bridge 230-4 connecting the first support body 200 to the beam with the gap 230-3 therebetween.

Referring to FIGS. 5A to 6, in an embodiment of the disclosure, the roller assembly accommodation unit 600 may have a first engagement step 610 supporting the first engagement protrusion 230-1, a second engagement step 620 supporting the second engagement protrusion 330, and a pressing groove 630 provided to be able to press the pressing protrusion 230-2 with a tool.

The first engagement step 610 and the second engagement step 620 of the roller assembly accommodation unit 600 may be provided to correspond to the first engagement protrusion 230-1 and the second engagement protrusion 330 of the roller assembly 10, respectively. For example, referring to FIG. 5B, the first engagement step 610 may be provided to protrude from one side of the roller assembly accommodation unit 600 toward the first engagement protrusion 230-1 to support the first engagement protrusion 230-1 and perform hook coupling, and the second engagement step 620 may be provided to protrude from the other side of the roller assembly accommodation unit 600 toward the second engagement protrusion 330 to support and catch the second engagement protrusion 330. However, the disclosure is not limited thereto, and the shapes of the first engagement step 610 and the second engagement step 620 may be variously provided according to the shapes of the first engagement protrusion 230-1 and the second engagement protrusion 330.

Referring to FIGS. 5B to 6, the pressing groove 630 may be understood as a certain gap provided between the roller assembly accommodation unit 600 and the pressing protrusion 230-2, and for example, may be provided as a gap into which the screwdriver D or the like may be inserted to press the pressing protrusion 230-2.

Although embodiments of the disclosure have been described above in detail, the scope of the disclosure is not limited thereto, and various modifications and alterations by those skill in the art using the basic concept of the disclosure defined in the following claims also fall within the scope of the disclosure.

The above descriptions of the disclosure are provided only for illustrative purposes, and those of skill in the art will understand that the disclosure may be easily modified into other detailed configurations without modifying technical aspects and essential features of the disclosure. Therefore, it should be understood that the above-described embodiments of the disclosure are exemplary in all respects and are not limiting of the scope of the disclosure.

For example, although the disclosure has been described with reference to the examples illustrated in the drawings, they are merely exemplary, and it will be understood by one of skill in the art that various modifications and equivalent embodiments may be made therefrom.

Therefore, the scope of the disclosure is defined by the following claims, and all modifications or alternatives derived from the scope and spirit of the claims and equivalents thereof fall within the scope of the disclosure.

According to an embodiment of the disclosure, a roller assembly may include a shaft, a first support body to which one end of the shaft is coupleable, a second support body to which another end of the shaft is coupleable, and a roller coupleable between the first support body and the second support body.

The roller may be rotatably supported by the shaft while the shaft is inserted into the roller.

The roller may have a cylindrical shape in which the shaft is insertable.

The first support body may include a protrusion that protrudes toward a side surface of the roller while the roller is coupled between the first support body and the second support body.

The protrusion of the first support body protrudes from the first support body is insertable into a space inside an outer circumference of the roller.

The second support body may include a protrusion that protrudes toward a side surface of the roller while the roller is coupled between the first support body and the second support body.

The protrusion of the second support body protrudes from the second support body is insertable into a space inside an outer circumference of the roller.

The roller may include an accommodation groove on one side surface of the roller to accommodate the protrusion of the first support body with a certain gap between the accommodation groove and the protrusion of the first support body.

The roller may include an accommodation groove on another side surface of the roller to accommodate the protrusion of the second support body with a certain gap between the accommodation groove and the protrusion of the second support body.

The shaft of the roller may not be exposed to the outside of the roller assembly while the shaft is inserted into the roller.

In an embodiment of the disclosure, the protrusion of the first support body and the second support body may respectively protrudes parallel to the shaft, and in a cross-sectional view perpendicular to the shaft, may be spaced apart from the shaft to have a ring shape around the shaft with a certain thickness.

In an embodiment of the disclosure, the accommodation grooves may be provided to face the outer circumferential surfaces and the inner circumferential surfaces of the protrusion of the first support body and the second support body in parallel.

In an embodiment of the disclosure, the accommodation grooves may be spaced apart from the outer circumferential surfaces of the protrusion of the first support body and the second support body, respectively, by 0.05 mm to 0.2 mm in a direction perpendicular to the outer circumferential surfaces of the protrusion of the first support body and the second support body.

In an embodiment of the disclosure, the roller may include a friction member to surround the outer circumferential surface of the roller, with a certain thickness and width.

In an embodiment of the disclosure, the friction member may be provided to have a width less than the width of the outer circumferential surface of the roller.

In an embodiment of the disclosure, the friction member may be formed of a material different from that of the roller.

In an embodiment of the disclosure, one end of the shaft may be detachably inserted into the support body facing the one end.

In an embodiment of the disclosure, the cross-sectional shape of the one end of the shaft may be a polygonal or elliptic cylinder shape.

In an embodiment of the disclosure, one of the first support body and the second support body facing the one end of the shaft may have an insertion groove corresponding to the shape of the one end of the shaft.

In an embodiment of the disclosure, a coupling unit having a snap-fit structure may be provided in an outer portion of the first support body.

In an embodiment of the disclosure, a second engagement protrusion may be provided in an outer portion of the second support body.

In an embodiment of the disclosure, the coupling unit may include a beam including a first engagement protrusion and a pressing protrusion, and a bridge to connect the beam to the first support body with a gap therebetween.

According to an embodiment of the disclosure, a vacuum cleaner may include a vacuum cleaner body including a built-in motor configured to generate a suction force, a brush body connectable to the vacuum cleaner body, and including a suction port to suck foreign substances from a surface to be cleaned, at least one roller assembly on a bottom surface of the brush body to cause the brush body to be rolling-moved on the surface to be cleaned, and at least one roller assembly accommodation unit arrangeable on the bottom surface of the brush body and having a structure corresponding to the at least one roller assembly such that the at least one roller assembly is able to be attached to or detached from the brush body.

The roller assembly may be provided on the bottom surface of the brush body.

The roller assembly may include a shaft, a first support body to which one end of the shaft is coupleable, a second support body to which another end of the shaft is coupleable, and a roller coupleable between the first support body and the second support body.

The roller may be rotatably supported by the shaft while the shaft is inserted into the roller.

The roller may have a cylindrical shape in which the shaft is insertable.

The first support body may include a protrusion that protrudes toward a side surface of the roller while the roller is coupled between the first support body and the second support body.

The protrusion of the first support body protrudes from the first support body is insertable into a space inside an outer circumference of the roller.

The second support body may include a protrusion that protrudes toward a side surface of the roller while the roller is coupled between the first support body and the second support body.

The protrusion of the second support body protrudes from the second support body is insertable into a space inside an outer circumference of the roller.

The roller may include an accommodation groove on one side surface of the roller to accommodate the protrusion of the first support body with a certain gap between the accommodation groove and the protrusion of the first support body.

The roller may include an accommodation groove on another side surface of the roller to accommodate the protrusion of the second support body with a certain gap between the accommodation groove and the protrusion of the second support body.

The shaft of the roller may not be exposed to the outside of the roller assembly while the shaft is inserted into the roller.

In an embodiment of the disclosure, the protrusion of the first support body and the second support body may respectively protrudes parallel to the shaft, and in a cross-sectional view perpendicular to the shaft, may be spaced apart from the shaft to have a ring shape around the shaft with a certain thickness.

In an embodiment of the disclosure, the accommodation grooves may be provided to face the outer circumferential surfaces and the inner circumferential surfaces of the protrusion of the first support body and the second support body in parallel.

In an embodiment of the disclosure, the roller may include a friction member to surround the outer circumferential surface of the roller, with a certain thickness and width.

In an embodiment of the disclosure, the friction member may be provided to have a width less than the width of the outer circumferential surface of the roller.

In an embodiment of the disclosure, the friction member may be formed of a material different from that of the roller.

In an embodiment of the disclosure, the cross-sectional shape of the one end of the shaft may be a polygonal or elliptic cylinder shape.

In an embodiment of the disclosure, one of the first support body and the second support body facing the one end of the shaft may have an insertion groove corresponding to the shape of the one end of the shaft such that the one end of the shaft may be detachably inserted into and coupled with the support body facing the one end.

In an embodiment of the disclosure, a coupling unit having a snap-fit structure may be provided in an outer portion of the first support body.

In an embodiment of the disclosure, a second engagement protrusion may be provided in an outer portion of the second support body.

In an embodiment of the disclosure, the coupling unit may include a beam including a first engagement protrusion and a pressing protrusion, and a bridge to connect the beam to the first support body with a gap therebetween.

In an embodiment of the disclosure, the roller assembly accommodation unit may have a first engagement step to support the first engagement protrusion, a second engagement step to support the second engagement protrusion, and a pressing groove provided between the pressing protrusion and the at least one roller assembly accommodation unit such that the pressing protrusion may be pressed with a tool.

1. A roller assembly comprising:
a shaft;
a first support body to which one end of the shaft is coupleable;
a second support body to which another end of the shaft is coupleable; and
a roller, coupleable between the first support body and the second support body, and having a cylindrical shape in which the shaft is insertable and rotatably supported by the shaft while the shaft is inserted,
wherein the first support body and the second support body respectively comprise a protrusion that protrudes toward side surfaces of the roller while the roller is coupled between the first support body and the second support body, the protrusion of the first support body and the second support body respectively protrude from the first support body and the second support body and is respectively insertable into a respective space inside an outer circumference of the roller, and
the roller comprises accommodation grooves on both side surfaces of the roller to respectively accommodate the protrusion of the first support body and the second support body in the accommodation grooves with certain gaps between the accommodation grooves and the protrusion of the first support body and the second support body, respectively, such that while the shaft is inserted into the roller, the shaft is unexposed to outside of the roller assembly.

2. The roller assembly of claim 1, wherein the protrusion of the first support body and the second support body respectively protrudes parallel to the shaft, and in a cross-sectional view perpendicular to the shaft, is spaced apart from the shaft to have a ring shape with a certain thickness around the shaft.

3. The roller assembly of claim 1, wherein the accommodation grooves face outer circumferential surfaces and inner circumferential surfaces of the protrusion of the first support body and the second support body in parallel.

4. The roller assembly of claim 1, wherein the accommodation grooves are spaced apart from outer circumferential surfaces of the protrusion of the first support body and the second support body, respectively, by 0.05 mm to 0.2 mm in a direction perpendicular to the shaft.

5. The roller assembly of claim 1, further comprising a friction member to surround an outer circumferential surface of the roller, with a certain thickness and width.

6. The roller assembly of claim 1, wherein a cross-sectional shape of one end of the shaft is a polygonal or elliptic cylinder shape, and
one of the first support body and the second support body facing the one end of the shaft comprises an insertion groove corresponding to a shape of the one end of the shaft.

7. The roller assembly of claim 1, wherein a coupling unit having a snap-fit structure is arranged in an outer portion of the first support body, and a second engagement protrusion is arranged on an outer portion of the second support body.

8. The roller assembly of claim 7, wherein the coupling unit comprises:
a beam comprising a first engagement protrusion and a pressing protrusion; and
a bridge to connect the first support body to the beam with a gap therebetween.

9. A vacuum cleaner comprising:
a vacuum cleaner body including a built-in motor configured to generate a suction force;
a brush body (V), connectable to the vacuum cleaner body, and including a suction port to suck foreign substances from a surface to be cleaned;
at least one roller assembly on a bottom surface of the brush body (V) to cause the brush body (V) to be rolling-moved on the surface to be cleaned; and
at least one roller assembly accommodation unit arrangeable on the bottom surface of the brush body (V) and having a structure corresponding to the at least one roller assembly such that the at least one roller assembly is able to be attached to or detached from the brush body (V),
wherein the at least one roller assembly comprises:
a shaft;
a first support body to which one end of the shaft is coupleable;
a second support body to which another end of the shaft is coupleable; and
a roller, coupleable between the first support body and the second support body, and having a cylindrical shape in which the shaft is insertable and rotatably supported by the shaft while the shaft is inserted,
the first support body and the second support body respectively comprise a protrusion that protrudes toward side surfaces of the roller while the roller is coupled between the first support body and the second support body, the protrusion of the first support body and the second support body respectively protrude from the first support body and the second support body and is respectively insertable into a respective space inside an outer circumference of the roller, and
the roller comprises accommodation grooves on both side surfaces of the roller to respectively accommodate the protrusion of the first support body and the second support body in the accommodation grooves with certain gaps between the accommodation grooves and the protrusion of the first support body and the second support body, respectively, such that while the shaft is inserted into the roller, the shaft is unexposed to outside of the at least one roller assembly.

10. The vacuum cleaner of claim 9, wherein the protrusion of the first support body and the second support body respectively protrudes parallel to the shaft, and in a cross-sectional view perpendicular to the shaft, is spaced apart from the shaft to have a ring shape with a certain thickness around the shaft.

11. The vacuum cleaner of claim 9, wherein the accommodation grooves face outer circumferential surfaces and inner circumferential surfaces of the protrusion of the first support body and the second support body respectively protrudes in parallel.

12. The vacuum cleaner of claim 9, further comprising a friction member surrounding an outer circumferential surface of the roller, with a preset thickness and width.

13. The vacuum cleaner of claim 9, wherein a cross-sectional shape of one end of the shaft is a polygonal or elliptic cylinder shape, and
one of the first support body and the second support body facing the one end of the shaft comprises an insertion groove corresponding to a shape of the one end of the shaft, such that the one end of the shaft is attachable to and detachable from the one of the first support body and the second support body that the one end of the shaft faces.

14. The vacuum cleaner of claim 9, wherein a coupling unit having a snap-fit structure is arranged in an outer portion of the first support body,
a second engagement protrusion is arranged on an outer portion of the second support body, and
the coupling unit comprises:
a beam comprising a first engagement protrusion and a pressing protrusion; and
a bridge connecting the first support body to the beam with a gap therebetween.

15. The vacuum cleaner of claim 14, wherein the at least one roller assembly accommodation unit comprises:
a first engagement step to support the first engagement protrusion;
a second engagement step to support the second engagement protrusion; and
a pressing groove between the pressing protrusion and the at least one roller assembly accommodation unit.
